(19) United States
(12) Patent Application Publication
(10) Pub. No.: US 2003/0076370 A1
(43) Pub. Date: Apr. 24, 2003

(54) Method and device for controlling a visual display unit for a rail traffic control system

(76) Inventor: Werner Hahn, Roetgesbuettel (DE)

Correspondence Address: MORRISON & FOERSTER LLP, 1650 TYSONS BOULEVARD, SUITE 300, MCLEAN, VA, 22102, US

(21) Appl. No.: 10/182,379

(22) PCT Filed: Jan. 24, 2001
(86) PCT No.: PCT/DE01/00329

(30) Foreign Application Priority Data
Jan. 28, 2000 (DE) 100047289

(51) Int. Cl. G08G 1/095

(52) U.S. Cl. 345/961; 340/907

(57) ABSTRACT

The invention relates to a method for displaying an image (AB) of a traffic situation of a rail track system on a display (12) of a pixel-oriented visual display unit (5) of a rail traffic control system (10), said display unit being controlled by means of a control device. According to the inventive method, the traffic situation is represented in such a manner that a viewer of the display (12) can recognize the traffic situation and can take control measures for influencing it. The aim of the invention is to provide a method which can be carried out at low costs while having a high safety standard. To this end, a visual display unit (5) is used as the visual display unit and has an internal matrix-oriented display memory (15) in which the image data required for the representation of the image (AB) are stored. The image is represented on the display against an image background whose brightness or color is adjusted according to the presence or absence of a control signal. Said control signal is automatically produced by means of the control device in an interval between the input of a user-end adjusting signal and the input of a user-end acknowledge signal.

The invention relates to a method for displaying an image of a traffic situation of a railway track system on a screen of a pixel-oriented display unit, actuated by means of a control device, of a railway control system, the traffic situation being represented in the method in such a way that a viewer of the screen can recognize the traffic situation and take control measures to influence it.

Such a method is known from the publication “Verfahrensgesicherte Meldebildanzeige für den Fdl-Arbeitsplatz bei der Deutschen Bahn AG” [Method-protected signal image display for the Fdl workstation at the Deutsche Bahn AG] (Horst Forstreuter und Achim Weitner-von Pein, Signal+Draht [signal and wire] 86, 1994, Volume 10, pages 320 to 324). This previously known method is an actuation method for a high-resolution, pixel-oriented display unit which is associated with a railway control system. Specifically, within the scope of the previously known method, an image of a traffic situation is represented on a railway track system on a screen of the display unit in such a way that a viewer or an operator of the railway control system can recognize and understand the traffic situation and take control measures or operational action in order to influence the traffic situation.

The invention is based on the object of improving a method of the type mentioned at the beginning to the effect that it can be carried out particularly cost-effectively while maintaining a high safety standard.

This object is achieved according to the invention with a method of the type specified at the beginning in that a display unit with a unit-internal, matrix-oriented display memory, in which the image data necessary for representing the image is stored, is used as the display unit, the image being represented on the screen against a screen background whose brightness or color is different when a control signal is present from when this control signal is absent, and the control signal being automatically formed by means of the control device in a time period between the inputting of a user-end adjusting signal and the inputting of a user-end acknowledge signal.

An essential advantage of the method according to the invention is that it can be carried out particularly cost-effectively as a display unit is used with a unit-internal, matrix-oriented image memory; this is because such display units—for example most types of LCD (liquid crystal display) screen, for example those using TFT technology—can be acquired very cost-effectively nowadays owing to their widespread use in what is referred to as the consumer field. It is known that very high safety standards are prescribed in the field of railway traffic technology; in order to be able to meet these safety standards, it is necessary to ensure that an incorrect image cannot appear on the screen at all or else is immediately recognizable to the user or the operator of the railway control system as incorrect. In the previously known method, this is achieved essentially in that display units without an image memory, for example standard monitors with a cathode ray tube, are used; in the previously known method, the image of the traffic situation is thus stored exclusively in the control device (PC or DP system) which actuates the display unit—specifically in the graphics card—so that any image memory can readily be read out or read back at the time in order to check the image contents. In contrast to this, in the method according to the invention it is not possible, or not readily possible, to read back the image information from the unit-internal image memory of the display unit because, specifically, the interfaces between the control device (computer) and display unit which are customary nowadays do not allow image information to be “read back”; this is because the interfaces operate exclusively unidirectionally. At this point the invention provides a further essential advantage; this is because in the method according to the invention the display unit is actuated in such a way that the image is represented on the screen against a screen background whose brightness or color is set differently when a control signal is present from when this control signal is absent. Owing to this method step, specifically image errors are very clearly apparent, as will now be explained below: in the case of an image with an image resolution of 1280×1024 pixels (that is to say an image matrix of 1280 rows and 1024 columns), a row address with 11 bits and a column address with 10 bits is necessary when coding the row and column numbering in the dual numerical format. If one of the row bits or column bits is defective here, for example in such a way that it then permanently has a logic “1” or a logic “0”, deviations occur between the image which is actually represented on the screen and the actually desired image. The effects of the bit errors owing to the binary coding are quite different here depending on their bit position in the binary coded row address or column address, as can easily be explained. The dual coding of the column numbering leads, described explicitly, to a situation in which the most significant bit (bit position n) defines whether the respective pixel should be in the left-hand or right-hand half of the image; the next least significant bit (bit position n−1) indicates whether the respective pixel is to be located in the right-hand or left-hand quarter of the image of the half of the image defined by the most significant bit. In a corresponding way, the other bits define which column is selected, the least significant bit defining whether the left-hand or the right-hand column of the column pair defined by the rest of the bits is selected. By simulating the image falsifications resulting from bit errors, the applicant has determined that bit errors in the most significant address bit of the binary address coding are particularly serious. If, specifically, an error occurs in this most significant bit, for example such an error that the bit always has a logic “1”, no new image information would be displayed any more on one side of the screen in the case of an incorrect column coding, or, on the upper or lower half of the screen in the case of an incorrect row coding, but instead only the “old” image information would be displayed. The image of the traffic situation would thus be partially “frozen” and no longer correct. For the viewer of the screen this would then not be directly apparent because it is, of course, impossible for him to know whether a changed traffic situation has occurred. In order to be able to make such errors relating to more significant bits or to the most significant bit clearly apparent, according to the invention the brightness or color of the screen background is continuously modified if a corresponding control signal is present. This control signal is, of course, only to be formed if it is to be checked whether the display on the screen is correct. If the desired whole-area change of the screen background occurs when the control signal is present, it is ensured that all the address bits, in particular the most significant address bit and also the other more significant address bits of the image memory are operating correctly. However, if stripes are formed on the screen background, this is due to the fact that one of the address bits has not switched over. This formation of stripes is generally very easy to detect on the screen. In the field of railway technology, it is always necessary to ensure that the display on the screen is correct if the traffic situation is being influenced by user-end control measures. In railway control systems, a control measure—as can be inferred, for example, from the publication mentioned at the beginning—usually takes place in two stages; in this context, the operator of the railway control system firstly generates an adjusting signal which characterizes the respective control measure. The control measure is then signalled by a corresponding change of the image of the traffic situation on the screen, as a result of which the operator is requested to generate an acknowledge signal which confirms the control measure. The control measure is then not influenced in reality at the control system end or signal tower end until the acknowledge signal is present. The time period after the adjusting signal is input and before the acknowledge signal is output is therefore particularly critical, with the result that in this time period a particularly large value has to be placed on a correct representation of the image of the traffic situation. According to the invention, the control signal is therefore generated in this time period; that is to say, therefore, that the change in the screen background has also been provided according to the invention in this time period. An additional essential advantage of the method according to the invention is that the display units used in this method with the unit-internal image memory—for example LCD screens as already stated above—generally operate without radiation or with very low radiaton so that the method according to the invention is also suitable for meeting the highest requirements in terms of the worker's protection for operators; in addition, it is to be noted that LCD screens also have the advantage that they are very insensitive to electromagnetic interference radiation and are thus defined by a very high level of electromagnetic compatibility.

Within the scope of a development of the method according to the invention it is also considered advantageous that at least on part of the screen a gridline pattern is displayed, the gridline width of which corresponds to the width of a screen pixel and the gridline spacing of which corresponds to an uneven multiple of the individual pixel spacing. Owing to this display of the gridline pattern, specifically display errors which are due to a bit error of the least significant address bit are particularly clearly apparent to an operator of the railway control system; this is because in the case of an error in the least significant bit such a gridline pattern can no longer be correctly displayed. If, specifically, the least significant bit is always logic “1” or always equal to logic “0”, every second row or column can no longer be addressed and can thus no longer be “written to”, which must inevitably lead to a clearly recognizable visual change in the gridline pattern.

The invention is also based on the object of specifying a control device for actuating a display unit with which, while maintaining a high safety standard, images of traffic situations can be represented on railway track systems in a particularly cost-effective way.

This object is achieved according to the invention by means of a control device for a railway control system for influencing a traffic situation on a railway track system and for actuating a pixel-oriented display unit in such a way that the latter displays the traffic situation on the railway track system, the control device being configured in such a way that it actuates the display unit in such a way that the latter represents the image of the traffic situation on the screen against a screen background whose brightness or color is dependent on the presence of a control signal in the control device, the control device also being configured in such a way that it automatically forms the control signal in a time period between the inputting of a user-end adjusting signal and the inputting of a user-end acknowledge signal.

The advantages of the control device according to the invention correspond to those which have already been explained in connection with the method according to the invention. The same applies to the development of the control device according to the invention as described in the subclaim, the advantages of which development can be derived from the statements above in conjunction with the development of the method according to the invention.

In the explanations above, reference was continuously made to an operator who is intended to recognize a representation error of the gridline pattern or of the screen background; it goes without saying that the recognition of an imaging error can also be carried out by machine in that, for example, the image of the screen is recorded with a video camera and then subjected in a computer to an image recognition system which is executed by machine. Within the scope of this image recognition method, the gridline pattern which is represented or the screen background which is shown is then conferred with a stored (correct) gridline pattern or screen background, and an alarm signal is generated if there is a deviation between the stored gridline pattern or screen background and the gridline pattern or screen background which is represented.

In order to explain the invention,

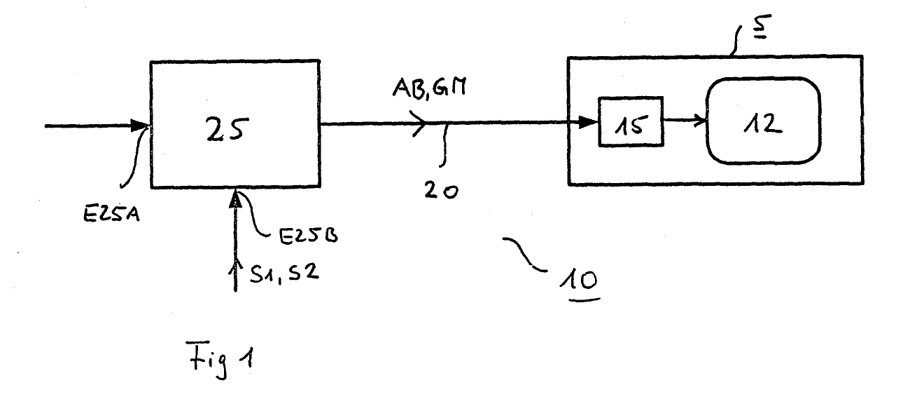

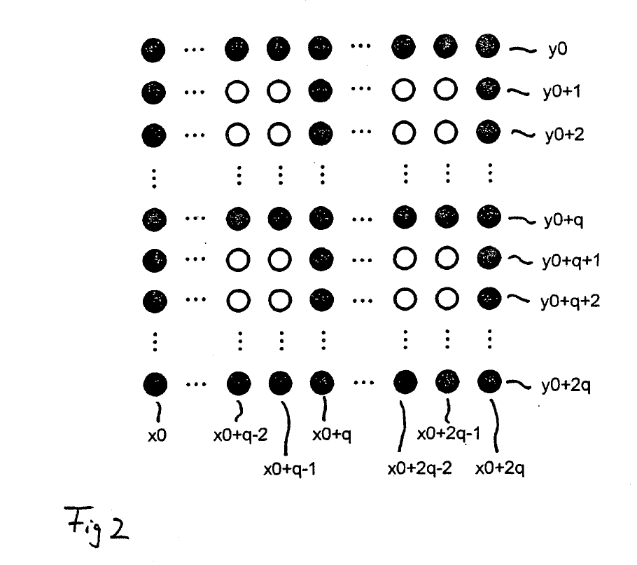

FIG. 1 shows an exemplary embodiment of an arrangement for carrying out the method according to the invention,

FIG. 2 shows a gridline pattern in a “pixel representation” for the exemplary embodiment according to FIG. 1,

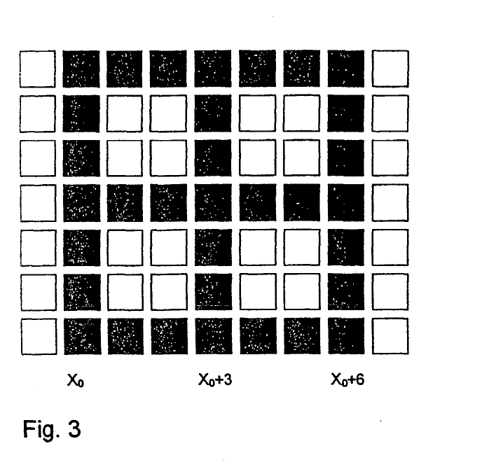

FIG. 3 shows the gridline pattern according to FIG. 2 in a simplified representation,

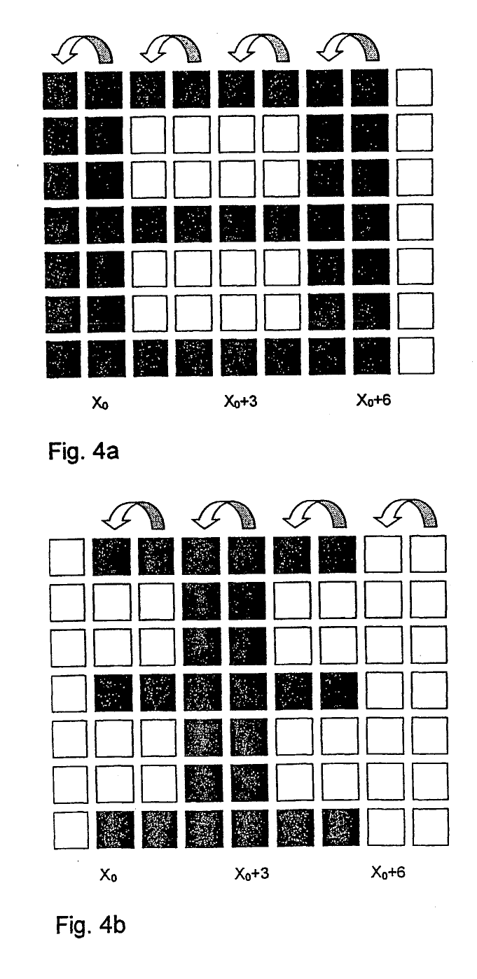

FIGS. 4a and 4b show representations of the gridline pattern according to FIG. 3 which are falsified by address bit errors, and

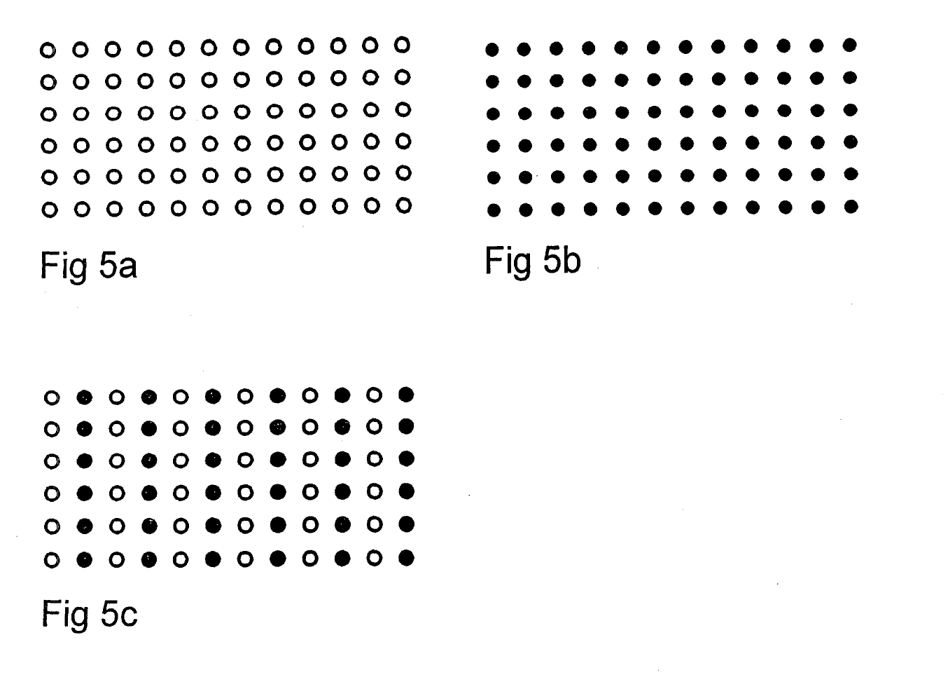

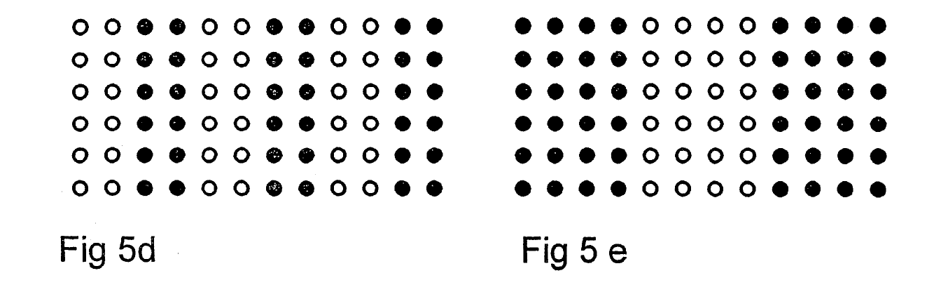

FIGS. 5a to 5e show screen backgrounds with and without address bit errors.

FIG. 1 shows a pixel-oriented display unit 5 of a railway control system 10. The display unit 5 can be, for example, an LCD display unit, in particular one using TFT technology, or even a plasma display unit. The display unit 5 of the railway control system 10 is used to represent an image AB of a traffic situation on a railway track system (not shown in FIG. 1), specifically in such a way that a viewer of the screen 12 of the display unit 5, or an operator of the railway control system 10, can recognize the traffic situation and take control measures to influence it. The display unit 5 has, at the input end, a unit-internal, matrix-oriented image memory 15 in which the image data necessary for representing the image on the screen 12 is stored.

The image memory 15 is connected via an interface 20 to a control device 25 which can be formed, for example, by a PC or DP system or a microprocessor arrangement. This control device 25 is connected by its one input E25A to sensors (not shown in FIG. 1) which transmit to the control device 25 the “traffic” or “situation” data which is necessary to represent the image of the traffic situation. The control device 25 is connected by its further input E25B to operator control devices (not shown in FIG. 1) in which the operator of the railway control system 10 can generate adjusting signals S1 or acknowledge signals S2 for influencing the traffic situation, and feed them into the control device 25. The control device 25 also has control outputs (not represented in FIG. 1) to which it passes on the operator-end measures for influencing the traffic situation—defined by the adjusting signals S1 and/or acknowledge signals S2—as corresponding output control signals to actuating elements (signals, railway switches, brakes, conveyor systems, etc.) of the railway track system.

The control device 25 which, as already mentioned above, can be formed by means of a microprocessor arrangement, is configured here, or programmed by means of a corresponding control program, in such a way that, in addition to the image of the traffic situation, it generates a gridline pattern GM and passes it on to the display unit 5 for display on the screen 12.

The gridline pattern is displayed here on part of the screen 12 which is not required for representing the image of the traffic situation, that is to say generally in the region of one of the edges of the screen.

An exemplary embodiment of the gridline pattern is shown in FIG. 2. This gridline pattern takes up a pixel range which is formed by the pixels with the column numbers between x0 and x+2q, and with the row numbers between y0 and y0+2q. X0 and y0 designate, as it were, the coordinates of the left-hand upper corner of the gridline pattern. The variable q indicates here the distance between the gridlines of the gridline pattern and should be an uneven number; for example q=“3” is possible.

FIG. 3 shows the gridline pattern according to FIG. 2 once more clearly for the case q=3 in an error-free case; that is to say a case in which the image memory 15 is operating correctly and representing correctly the gridline pattern generated by the control device 25. As can be clearly recognized in FIGS. 2 and 3, the gridline width corresponds to the width of one screen pixel.

Below, there will now be an explanation of the representation errors which occur if the memory cells of the image memory 15 can no longer be addressed correctly; here, it is, for example, firstly assumed that the least significant address bit A(0) of the column address is no longer operating correctly and is permanently “0” or “1” (A(0)=0 or A(0)=1). In this case, the corresponding image memory cells retain their least significant address bit A(0)=0 or A(0)=1, inevitably that content which had been assigned to them last—that is to say during the last writing operation to occur—before the failure of the address bit A(0). In terms of the content of the faulty cells, it is assumed that the image memory 15 firstly operates correctly so that the gridline pattern according to FIG. 2 or 3 is originally represented correctly, and that the defect in the image memory only occurs subsequently. The “frozen” content of the faulty cells can thus be read out for the two error cases examined below, indicated in FIG. 3:

Error case 1:

Firstly, the case will be examined in which the least significant address bit A(0) of the column address is permanently at “0” (A(0)=0). In this case, the columns can no longer be addressed with an uneven column number and thus remain frozen. In contrast to this, the even columns are addressed twice; specifically, firstly the correct image information is in fact written into an image cell with an even column number. Then, if the respective next column is actually to be addressed with an uneven column number, the addressing error then occurs because the address bit A(0) cannot be switched over from “0” to “1”. This then leads to a situation in which the image information which was actually intended for the next column is written once more into the column with the even column number; the correct image contents of this column are therefore overwritten, specifically with the image information which was intended for the next column with the uneven column number.

In the examination of the error case 1, the assumption is therefore made that the columns are addressed successively one after the other in the direction of rising column numbers. In the case of rapid memory writing or rapid image composition, exclusively the incorrect image contents are thus displayed in all columns with an even column number.

FIG. 4a shows the pattern which is obtained in error case 1 if the column number x0 of the image memory cell of the left-hand upper corner of the gridline pattern is uneven; FIG. 4b shows the resulting pattern for the case in which the column number x0 is even.

Error case 2:

The case in which the least significant address bit A(0) is continuously at “1” (A(0)=1) will now be examined. In the error case 2, the columns with even column numbers are therefore “frozen”, and the uneven columns are addressed twice. The addressing error therefore always becomes visible if the address bit A(0) is to be switched over from “1” to “0”. Whereas this is in fact not possible owing to the address bit error, when there is an attempt to write to a column with an even column number, the respective next column with an uneven column number is actually addressed, and the image information is written into it. Then, when it is the turn of this next column with an uneven column number these incorrect image contents are however overwritten with the correct image contents. Depending on the speed of the writing operation or of the image composition, the error case 2 may thus be difficult to recognize or possibly even impossible to recognize under certain circumstances, as the incorrect gridline pattern occurs only for a very short time.

In order to be able to reliably detect the error case 2, and in addition also to be able to display bit errors at different locations of the binary address coding, in the arrangement according to FIG. 1, there is additionally provision for the screen background to be changed in terms of its color or brightness whenever control measures for influencing the traffic situation on the railway track system are to be performed by the operator of the railway control system 10. As already explained above, a control measure in the field of railway technology usually takes place in two stages: in the first stage the operator enters an adjusting signal S1 which indicates the type of control measure. If, for example, a signal XY is to be adjusted “to go” (to the go setting or go signal), the operator generates the adjusting signal S1 with the information “set signal XY to go”. After the adjusting signal S1 is input, the railway control system 10 then displays the railway track system with a correspondingly marked signal, as a result of which the operator is clearly shown which adjusting signal he has generated. If the display corresponds to that which the operator desires as a control measure, he generates an acknowledge signal S2 with which the adjusting signal is confirmed in terms of content, and the corresponding instruction “set signal XY to go” is executed by the control device 25. In the period between the inputting of the adjusting signal S1 and the inputting of the acknowledge signal S2, it is therefore necessary to ensure that the image displayed on the screen 12 actually corresponds to that which was generated, as image, by the control device 25.

In order to achieve this, after the adjustment signal S1 is input, a control signal is generated in the control device 25, which control signal is deleted or withdrawn again by the control device 25 only if the acknowledge signal S2 is present. In addition, in the period in which the control signal is present, the screen background—in which the image of the traffic situation is represented—changes over the entire area or at least over a very large area, for example in terms of color or brightness. FIGS. 5a and 5b show how this actually looks; FIG. 5a shows here the screen background in a pixel representation in its original form—that is to say before the change—and FIG. 5b after it, that is to say after the modification. For technical printing reasons, the change was represented here in such a way that the previously white pixels are then black. Of course, the modification of the screen background in terms of a change of color or brightness must be such that the image of the traffic situation can be clearly recognized both before and after the modification. For example, a change in brightness from a light gray background to a dark gray background is possible.

FIG. 5c shows how the screen background looks if the least significant bit A(0) of the column address—referred to below as first bit A(0)—is faulty. FIG. 5c actually shows a formation of stripes with a stripe width of one pixel.

FIG. 5d shows how the screen background looks if the next most significant bit A(1) on the column address—referred to as second bit A(1)—after the least significant bit A(0) is faulty. FIG. 5d shows a formation of stripes with a stripe width of two pixels.

FIG. 5e shows how the screen background looks if the next most significant bit A(2)—referred to below as third bit A(2)—after the second bit A(1) is faulty: the width of the stripes is four pixels.

Corresponding screen backgrounds are obtained for more significant bit errors; specifically, the stripe width is greater, the higher the “ranking” of the bit; at the ith bit, the column width would specifically be 2ⁱ⁻¹ pixels.

In conclusion it is to be noted that the representation of the gridline pattern can be limited to the period in which the control signal is present. Specifically, the gridline pattern would then not be generated in this case until after an adjusting signal is input. Preferably, the gridline pattern should be displayed on a screen region in which otherwise only the screen background is visible. This refinement of the gridline pattern representation provides specifically the advantage that the error case 2 described above can also be recognized immediately at the user end: if specifically the gridline pattern is not built up correctly, an addressing error is present.

1. Method for displaying an image (AB) of a traffic situation of a railway track system on a screen (12) of a pixel-oriented display unit (50), actuated by means of a control device (25), of a railway control system (10),
the traffic situation being represented in the method in such a way that a viewer of the screen (12) can recognize the traffic situation and take control measures to influence it, characterized in that
a display unit (5) with a unit-internal matrix-oriented display memory (15), in which the image data necessary for representing the image (AB) restored, is used as the display unit,
the image (AB) being represented on the screen (12) against a screen background whose brightness or color is different when a control signal is present from when this control signal is absent, and
the control signal being automatically formed by means of the control device (25) in a time period between the inputting of a user-end adjusting signal (S1) and the inputting of a user-end acknowledge signal (S2).

2. The method as claimed in claim 1, characterized in that
the display unit (5) is actuated in such a way that it displays a gridline pattern on at least part of the screen (12),
the gridline width of which corresponds to the width of a screen pixel and
the gridline spacing of which corresponds to an uneven multiple of the individual pixel spacing.

3. A control device for a railway control system
for influencing a traffic situation on a railway track system, and
for actuating a pixel-oriented display unit (5) in such a way that the latter displays an image (AB) of the traffic situation on the railway track system, characterized in that
the control device (25) is configured in such a way
that it actuates the display unit (5) in such a way that the latter represents the image (AB) of the traffic situation on the display (12) against a screen background whose brightness or color is dependent on the presence of a control signal in the control device (25), and
the control device (25) additionally being configured in such a way
that it automatically forms the control signal in a time period between the inputting of a user-end adjusting signal (S1) and the inputting of a user-end acknowledge signal (S2).

4. The control device as claimed in claim 3, characterized in that
the control device (25) is configured in such a way that it actuates the display unit (5) in such a way that the latter displays a gridline pattern on at least part of the screen (12),
the gridline width of which corresponds to the width of a screen pixel, and
the gridline spacing of which corresponds to an uneven multiple of the individual pixel spacing.
